(19) United States
(12) Patent Application Publication
(10) Pub. No.: US 2025/0114849 A1
(43) Pub. Date: Apr. 10, 2025

(54) CUTTING TOOL AND TOOL HOLDER FOR A ROTARY CUTTING DEVICE

(71) Applicant: QUADCO INC., Saint-Eustache (CA)

(72) Inventors: Charles HENRICHON, Saint-Eustache (CA); Etienne MINVILLE, Saint-Eustache (CA)

(73) Assignee: QUADCO INC., Saint-Eustache (CA)

(21) Appl. No.: 18/904,632

(22) Filed: Oct. 2, 2024

Related U.S. Application Data
(60) Provisional application No. 63/587,794, filed on Oct. 4, 2023.

(30) Foreign Application Priority Data
Oct. 4, 2023 (CA) 3215283

(51) Int. Cl. B23C 5/20

(52) U.S. Cl. CPC B23C 5/202; B23C 2200/161

(57) ABSTRACT

The present disclosure relates to a cutting tool system comprising a tool holder and a cutting tool. The tool holder includes a base for mounting onto a rotary drum or disc and a body for removably coupling to the cutting tool. The cutting tool is for size-reducing a material and has a first side and a second side. The cutting tool includes a plurality of cutting edges that are selectively moveable into and out of a cutting path of the rotary drum or disc. The first and second sides each have at least one cutting edge, such that each of the first and second sides are configured to be a leading side of the cutting tool during use. This allows the cutting tool to be rotated and/or reversed, such that a single cutting tool provides several cutting edges and increases the wear or erosion life thereof.

### TECHNICAL FIELD

This disclosure generally relates to cutting tools and tool holders for mulcher and mower heads and cutting drums or discs thereof. Specifically, this disclosure relates to cutting tools with features to increase the wear or erosion life of the cutting tool.

### BACKGROUND

Cutting devices comprising a rotating drum or a rotary disc with cutting teeth are used to shred, cut, or size reduce a material. As the drum or disc rotates, the cutting edge of the teeth dig into the material and remove a depth of the material being shredded to size reduce the material. As the teeth come into contact with the material being shredded, they become dull or blunt, which can increase the overall cutting resistance of the rotary drum or disc. An increase in the cutting resistance can increase the fuel consumption of the machine the rotary drum or disc is being used with. Moreover, an increase in the cutting resistance can increase stress on the other machine components and decrease productivity as the rotational speed of the rotating drum is decreased.

Once conventional teeth for rotary drums or discs become blunt or dull, they are removed from the rotary drum or disc and replaced with new teeth, which increases the overall cost and maintenance time associated with operating the rotary drum or disc. In some instances, conventional teeth have cutting edges with a single straight edge that extends from either side wall of the tooth or a v-shape edge with two straight edges that converge at or near the center of the cutting tooth at an apex. Straight cutting edges are prone to being worn down and becoming dull and/or blunt, thus increasing the amount of replacement and/or maintenance required with the rotating drum.

In view of the above, there is a need for more cost effective and efficient devices that would be able to overcome or at least minimize some of the above-discussed prior art concerns.

### SUMMARY

It is therefore an aim of the present invention to address the above-mentioned issues.

According to one embodiment, there is provided a cutting tool system comprising: a tool holder comprising a base for mounting onto a rotary drum or disc and a body; and a cutting tool for size-reducing a material, the cutting tool having a first side and a second side and being configured to couple to the body of the tool holder, the cutting tool comprising a plurality of cutting edges that are selectively moveable into and out of a cutting path of the rotary drum or disc, wherein the first side and the second side have at least one of the plurality of cutting edges, such that each of the first side and the second side are configured to be a leading side of the cutting tool.

In some embodiments, each of the first side and the second side comprise: a cutting side having cutting surfaces and an abutting surface positioned between the cutting surfaces; a side opposing the cutting side; opposing relief surfaces adjacent to the cutting side; and opposing support surfaces extending between the opposing relief surfaces.

In some embodiments, the plurality of cutting edges comprises opposing cutting edges at an apex of a given one of the opposing relief surfaces and an adjacent one of the cutting surfaces on the first side and the second side.

In some embodiments, the side opposing the cutting side of the first side and the side opposing the cutting side of the second side are adjacent and coupled at 90° relative to each other such that a given one of the opposing relief surfaces on the first side is on a same side of the cutting tool as a given one of the opposing support surfaces on the second side of the cutting tool.

In some embodiments, the body of the tool holder further comprises cutting tool support platform having a support face configured to engage with a rotary drum or disc facing side of the cutting tool and a protrusion having an abutting face configured to engage with the abutting surface on a trailing side of the tool holder.

In some embodiments, when coupled to the tool holder, a given one of the opposing support surfaces and a top side of the protrusion are coplanar.

In some embodiments, the protrusion comprises a tool holder aperture extending through the protrusion and the cutting tool further comprises a cutting tool aperture extending between the abutting surface on the first side and the abutting surface on the second side, wherein, when reversible coupled thereto, the tool holder aperture and the cutting tool aperture are configured to align to define a central axis of the cutting tool system and receive a fastener to reversibly couple the cutting tool to the tool holder on the rotary drum or disc.

In some embodiments, the cutting tool is configured to be rotated around the central axis to selectively move the plurality of cutting edges into and out of the cutting path.

In some embodiments, the cutting tool is configured to be rotated around an axis perpendicular to the central axis to selectively move the plurality of cutting edges into and out of the cutting path.

In some embodiments, the support face on the cutting tool support platform is configured to engage with a given one of the opposing support surfaces of the cutting tool.

In some embodiments, the support face has a protruding convex shape with a leading side that is configured to abut against a recess surface adjacent to the given one of the opposing support surfaces, wherein the recess surface is between an adjacent one of the opposing relief surfaces and the given one of the opposing support surfaces on an opposing one of the first side and the second side.

In some embodiments, the support face and the abutting face are provided at an angle of between about 90° and about 120°.

In some embodiments, the angle is between about 90° and about 100°.

In some embodiments, the abutting surface on the first side and the abutting surface on the second side protrude past an edge of the opposing support surfaces to form a protruding abutment comprising: side support surfaces between an adjacent one of the opposing support surfaces and the abutting surface; and cutting side surfaces between an adjacent one of the cutting surfaces and the abutting surface.

In some embodiments, a leading side of the body comprises chamfered edges.

In some embodiments, when reversible coupled, the chamfered edges and the cutting side surfaces are configured to engage with each other.

In some embodiments, when reversible coupled, the chamfered edges and the cutting surfaces are configured to engage with each other.

In some embodiments, each of the opposing relief surfaces are angled laterally inwardly from an apex with the recess surface at a relief angle.

In some embodiments, the relief angle is between about 0.5° and about 15°.

In some embodiments, the relief angle is between about 1° and about 3°.

In some embodiments, the cutting tool system further comprises the rotary drum or disc, wherein the tool holders are coupled to an outer surface of the rotary drum or disc in a spaced apart manner configured to limit an amount of the material a given one of the plurality of cutting edges in the cutting path has access to.

In some embodiments, the tool holders are spaced apart in a spiral or helical configuration.

According to another aspect, there is provided a cutting tool for mounting onto a rotary drum or disc for shredding a material, the cutting tool having a first side and a second side configured to be a leading side of the cutting tool, each of the first side and the second side comprising: a cutting side having cutting surfaces and an abutting surface positioned between the cutting surfaces; a side opposing the cutting side; opposing relief surfaces adjacent to the cutting side; opposing support surfaces extending between the opposing relief surfaces; and opposing cutting edges at an apex of a given one of the opposing relief surfaces and an adjacent one of the cutting surfaces; wherein the side opposing the cutting side of the first side and the side opposing the cutting side of the second side are adjacent and coupled at 90° relative to each other such that a given one of the opposing relief surfaces on the first side is on a same side of the cutting tool as a given one of the opposing support surfaces on the second side of the cutting tool.

In some embodiments, the cutting tool further comprises an aperture extending between the abutting surface on the first side and the abutting surface on the second side, the aperture being configured to receive a fastener to reversibly couple the cutting tool to the rotary drum or disc or a tool holder on the rotary drum or disc.

In some embodiments, the aperture defines a central axis of the cutting tool.

In some embodiments, the cutting tool is configured to be rotated around the central axis of the aperture to selectively move the opposing cutting edges of the first side or the second side into and out of a cutting path of the rotary drum or disc.

In some embodiments, the cutting tool is configured to be rotated around an axis perpendicular to the central axis of the aperture to selectively move the opposing cutting edges of the first side or the second side into and out of a cutting path of the rotary drum or disc.

In some embodiments, the cutting tool further comprises a recess surface between the given one of the opposing relief surfaces on the first side and the given one of the opposing support surfaces on the second side and/or between the given one of the opposing relief surfaces on the second side and the given one of the opposing support surfaces on the first side.

In some embodiments, adjacent ones of the given one of the opposing relief surfaces and the given one of the opposing support surfaces are offset from each other such that the recess surface extends in a different direction than the adjacent ones of the given one of the opposing relief surfaces and the given one of the opposing support surfaces.

In some embodiments, the recess surface is curved.

In some embodiments, the recess surface is curved with a continuous radius.

In some embodiments, the recess surface comprises a tapered planar surface that is separated from an adjacent one of the opposing support surfaces by a radius.

In some embodiments, each of the opposing relief surfaces are angled laterally inwardly from an apex with the recess surface at a relief angle.

In some embodiments, the relief angle is between about 0.5° and about 15°.

In some embodiments, the relief angle is between about 1° and about 3°.

In some embodiments, the abutting surface on the first side and the abutting surface on the second side protrude past an edge of the support surface to form a protruding abutment.

In some embodiments, the protruding abutment comprises: side support surfaces between an adjacent one of the opposing support surfaces and the abutting surface; and cutting side surfaces between an adjacent one of the cutting surfaces and the abutting surface.

In some embodiments, the side support surfaces are configured to abut a corresponding surface on the rotary drum or disc or a tool holder on the rotary drum or disc.

In some embodiments, the side support surfaces and the corresponding surface are complementary surfaces that are configured to engage with each other.

In some embodiments, the cutting side surfaces have a profile that is configured to prevent the material from catching or snagging on the protruding abutment.

In some embodiments, the profile is chamfered, curved, or rounded.

In some embodiments, the cutting side surfaces comprise two concave recesses that each extend partially along a length of the protruding abutment.

In some embodiments, the two concave recesses are separated by a bridge.

In some embodiments, the bridge has a protruding height that is substantially equal to a protruding height of the protruding abutment.

In some embodiments, protruding abutment further comprises a pocket around the aperture that is configured to receive a head of a fastener.

In some embodiments, an internal surface of the pocket has at least one side that is a rotation stopper for the head of the fastener.

In some embodiments, the opposing cutting edges comprise grooves or serrations.

According to another aspect, there is provided a cutting tool configured to size-reduce material, the cutting tool comprising a plurality of cutting edges that are selectively moveable into and out of a cutting path of the rotary drum or disc, wherein at least two of the plurality of cutting edges are on opposing sides of the cutting tool, such that each of the opposing sides are configured to be a leading side of the cutting tool.

According to another aspect, there is provided a cutting tool for mounting onto a rotary drum or disc for size-reducing a material, the cutting tool comprising opposing sides with at least one cutting edge, wherein the opposing sides are configured to be a leading side of the cutting tool such that the at least one cutting edge is a cutting edge in a cutting path of the rotary drum or disc.

According to another aspect, there is provided a cutting tool for mounting onto a rotary drum or disc for size-reducing a material, the cutting tool comprising a plurality of cutting edges, wherein the cutting tool is configured to be reversible and rotatable, such that each of the plurality of cutting edges are configured to be a cutting edge in the cutting path.

According to another aspect, there is provided a mulcher head configured to mulch, shred, or size-reduce a material, the mulcher head comprising: a frame; a cutting drum rotatably mounted to the frame; an actuator for rotating the cutting drum; and a plurality of cutting tool systems removably couplable to the cutting drum; wherein at least one of the plurality of cutting tool systems are the cutting tool systems as defined herein.

According to another aspect, there is provided a mulcher head configured to mulch, shred, or size-reduce a material, the mulcher head comprising: a frame; a cutting drum rotatably mounted to the frame; an actuator for rotating the cutting drum; and a plurality of cutting tool systems removably couplable to the cutting drum; wherein at least one of the plurality of cutting tool systems comprises a tool holder and a cutting tool as defined herein, wherein the tool holder comprises a base configured to couple to the cutting drum and a body configured to couple to the cutting tool.

### BRIEF DESCRIPTION OF THE DRAWINGS

In order that the invention may be readily understood, embodiments of the invention are illustrated by way of example in the accompanying drawings.

FIG. 1 is a perspective side view of a cutting tool according to one embodiment;

FIG. 2 is a leading side view of a first side of the cutting tool shown in FIG. 1;

FIG. 3 is a side view of the first side and a second side of the cutting tool shown in FIG. 1;

FIG. 4 is a perspective leading side view of a tool holder according to one embodiment that is configured to couple to a cutting tool, such as the cutting tool shown in FIG. 1;

FIG. 5 is a perspective trailing side view of the tool holder shown in FIG. 4;

FIG. 6 is a top side view of the tool holder shown in FIG. 4;

FIG. 7 is a side view of the tool holder shown in FIG. 4;

FIG. 8 is an exploded side view of a cutting tool system according to one embodiment, showing the cutting tool of FIG. 1, the tool holder of FIG. 4, and a fastener;

FIG. 9A is a side view of the cutting tool system shown in FIG. 8, showing the cutting tool of FIG. 1 coupled to the tool holder of FIG. 4 with the fastener in a first position;

FIG. 9B is a cross-sectional side view of the cutting tool system shown in FIG. 8, showing the cutting tool of FIG. 1 coupled to the tool holder of FIG. 4 with the fastener in a first position;

FIG. 10 is an exploded perspective side view of the cutting tool system shown in FIG. 8;

FIG. 11 is a perspective side view of the cutting tool system shown in FIG. 8, showing the cutting tool of FIG. 1 coupled to the tool holder of FIG. 4 with the fastener in a second position;

FIG. 12 is a top side view of the cutting tool system shown in FIG. 8;

FIG. 13 is a perspective leading side view of a cutting drum according to one embodiment, showing the cutting tool system shown in FIG. 8 coupled in a spaced apart manner to an outer surface of the cutting drum;

FIG. 14 is a side view of the cutting drum shown in FIG. 13 and the cutting tool system shown in FIG. 8;

FIG. 15 is a side view of a cutting tool according to another embodiment, showing a first side and a second side thereof;

FIG. 16 is a perspective side view of the cutting tool shown in FIG. 15;

FIG. 17 is a side view of a cutting tool according to another embodiment, showing a first side and a second side thereof;

FIG. 18 is a perspective side view of the cutting tool shown in FIG. 17;

FIG. 19 is an exploded perspective side view of a cutting tool according to another embodiment and a fastener;

FIG. 20 is a leading side view of the cutting tool shown in FIG. 19;

FIG. 21 is a perspective side view of a cutting tool according to another embodiment;

FIG. 22 is a leading side view of the cutting tool shown in FIG. 21;

FIG. 23 is a side view of the cutting tool shown in FIG. 21, showing a first side and a second side thereof;

FIG. 24 is a perspective leading side view of a tool holder according to another embodiment that is configured to couple to a cutting tool, such as the cutting tool shown in FIG. 1;

FIG. 25 is a side view of the tool holder shown in FIG. 24;

FIG. 26 is a perspective trailing side view of the tool holder shown in FIG. 24;

FIG. 27 is a perspective leading side view of a tool holder according to another embodiment that is configured to couple to a cutting tool, such as the cutting tool shown in FIG. 15 or FIG. 17;

FIG. 28 is a side view of the tool holder shown in FIG. 27;

FIG. 29 is a perspective trailing side view of the tool holder shown in FIG. 27;

FIG. 30 is an exploded perspective side view of a cutting tool system showing a tool holder according to another embodiment, the cutting tool of FIG. 15, and a fastener;

FIG. 31 is an exploded side view of the cutting tool system shown in FIG. 30;

FIG. 32 is a side view of the cutting tool system shown in FIG. 30; and

FIG. 33 is a side view of the cutting tool system shown in FIG. 30.

### DETAILED DESCRIPTION

As used herein, references to “leading” refers to the direction or side of the direction of rotation D_{R} of the disc, whereas “trailing” refers to the direction or side that is opposite the direction of rotation D_{R} of the disc.

As used herein, “substantially”, “approximately”, and/or “about” means an acceptable variation according to conventional standards, otherwise at most a 5% to 10% variation from an indicated effect or value.

Rotating assemblies, such as drums or discs, can be used with stump grinders, mulchers, and/or feller bunchers that are configured to grind stumps, mulch organic or other matter, mow organic or other matter, clear land, and/or cut or fell trees or shrub. The assembly is coupled to a means of rotation, such as a drive shaft, and can be mountable on a movable working arm or boom of a self-propelled vehicle or hand-held device. The assembly can be mounted to the means of rotation horizontally or vertically.

There is provided a cutting tool that has features to increase the wear or erosion life of the cutting tool and reduces maintenance time in replacing the cutting tools. When the rotary drum or disc is rotated, the cutting tools are susceptible to damage from impacting objects other than the organic material being shredded or grinded, such as rocks. When the cutting resistance on a given cutting edge in the cutting path increases, the efficiency of the rotary drum or disc decreases, requiring the given cutting edge to be sharpened or replaced. To reduce the maintenance requirement, the cutting tool includes a plurality of edges that are selectively moveable into and out of the cutting path of the rotary drum or disc the cutting tool is being used with. When the given cutting tool in the cutting path requires replacement, the cutting tool can be rotated or reversed to provide a fresh or new cutting edge. In some embodiments, when all of the plurality of cutting edges are dull or otherwise at the edge of their wear or erosion life, each of the cutting edges on the cutting tool are configured to be sharpened, including, optionally, while being coupled to the tool holder.

In some embodiments, the cutting tool is configured to be rotatable such that the cutting tool has more than one cutting edge on the leading side that can be used until the end of the cutting edge's wear or erosion life. For example, when a leading side of the rotatable cutting tool includes two cutting edges, the wear or erosion life of the cutting tool can be at least doubled by rotating the cutting tool to utilize the second cutting edge. In some embodiments, the cutting tool is configured to be reversible such that the cutting tool has more than one cutting edge on opposing or adjacent surfaces, such that multiple surfaces on the cutting tool are configured to be the leading side of the cutting tool. In some embodiments, the cutting tool has two opposing cutting edges on a first side and two opposing cutting edges on a second side. In this embodiment, both the first side and the second side are rotatable to each provide two wear or erosion lives of the cutting tool. Moreover, the cutting tool is reversible, such that the cutting tool can be flipped to orientate the first side or the second side as the leading side, thus providing a total of four erosion or wear lives to the cutting tool (i.e., two erosion or wear lives on the first side and two erosion or wear lives on the second side).

There is also provided a tool holder that is configured to be mounted on or otherwise coupled to the outer surface of a rotary drum or disc and be reversibly coupled to a cutting tool. The tool holder provides a space to receive the cutting tool and allow each of the multitude of cutting edges to be sharpened.

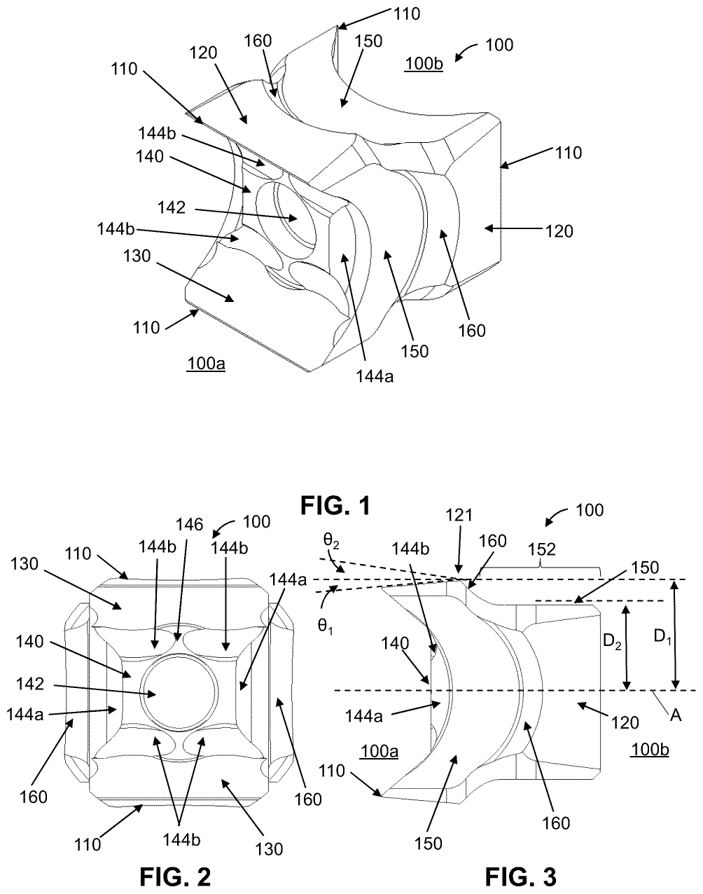

Referring now to FIGS. 1 to 3, a cutting tool 100 according one embodiment is shown. The cutting tool 100 has a first side 100a and a second side 100b, each with a plurality of cutting edges 110. The cutting edges 110 are provided at an apex of a relief surface 120 and a cutting surface 130. Each of the first side 100a and the second side 100b include an abutting surface 140 with an aperture 142 extending between the two abutting surfaces that is configured to receive a fastener. In the exemplary embodiment, each of the first and second sides 100a, 100b include two opposing cutting edges 110 with support surfaces 150 extending substantially perpendicular to the opposing relief surfaces 120.

In some embodiments, the first and second sides 100a, 100b can be substantially similar and/or have mirror symmetry to each other. In the exemplary embodiment, the first side 100a and the second side 100b are substantially similar with a side opposing the cutting side (i.e., the side with the cutting surfaces 130) of the first and second sides being adjacent and coupled at a 90° rotation relative to each other along a center axis of the aperture 142 (which is coaxial with an axis A of the fastener). In other words, the cutting edges 110 of the two opposing relief surfaces 120 on the first side 100a extend in a perpendicular direction to the cutting edges 110 on the two opposing relief surfaces 120 on the second side 100b.

When opposing cutting edges 110 of the first and second sides 100a, 100b are perpendicular to each other, the support surfaces 150 on the first side 100a abut the relief surface 120 on the second side 100b and vice versa. In some embodiments, the adjacent relief surface 120 and support surface 150 (i.e., one of the first side 100a relief surface 120 and the adjacent second side 100b support surface 150, and vice versa) can be substantially co-planar. In the exemplary embodiment, the adjacent relief surface 120 and support surface 150 are offset from each other and separated by a recess surface 160. As best shown in FIG. 3, the recess surface 160 is curved inwardly from the relief surface 120; however, other orientations are contemplated, such as planar, angular, stepwise, etc. In the exemplary embodiment, the relief surface 120 is planar and angled slightly and the support surface 150 is planar and substantially perpendicular with the cutting edge 110.

In some embodiments, the relief surface 120 can be angled laterally inwardly from an apex 121 between the relief surface 120 and the recess surface 160 at a relief angle θ₁, such that the cutting edge 110 is displaced inwardly of the apex 121. The relief angle θ₁ can be between about 0.1° and about 15°, or between about 3° and about 7°. In the exemplary embodiment, the relief angle θ₁ is about 5°. In other embodiments, the relief surface can be angled laterally outwardly from the apex 121 between the relief surface 120 and the recess surface 160 at a relief angle θ₂, such that the cutting edge 110 is displaced outwardly of the apex 121. The relief angle θ₂ can be between about 0.1° and about 15°, or between about 3° and about 7°.

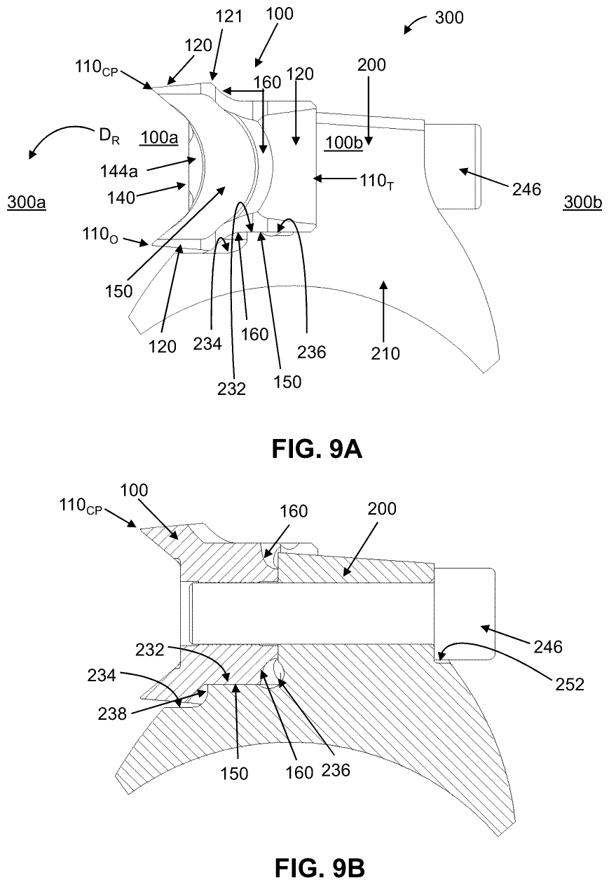

In the exemplary embodiment, the relief surfaces 120 have a distance D₁ from the aperture 142 that is larger than the distance D₂ between the support surfaces 150 and the aperture 142 (i.e., when viewing the first side 100a as the leading side on a cutting drum, the relief surfaces 120 extend further in the radial direction, such that the cutting edge 110_{CP} in the cutting path (in this example, being the top cutting edge 110 on the first side 100a in FIG. 1, and shown in FIG. 9A) has a further radial distance from the axis of rotation of the cutting drum than the adjacent support surface 150. As the adjacent support surface 150 is on a trailing side of the cutting edge 110_{CP} in the cutting path, when the cutting drum is being rotated, the support surface 150 provides a recessed area 152. In other words, when the first side 100a is in the cutting path, the support surfaces 150 on the second side 100b provides recesses 152 on a trailing side of the first side 100a relief surfaces. In some embodiments, the recess 152 can provide space for the adjacent relief surface 120 to be re-sharpened, for example manually sharpened with a grinder and/or buffer.

In some embodiments, the abutting surface 140 can protrude slightly past an edge of the support surface 150, which can be referred to as a protruding abutment, as is best shown in FIG. 3. In the exemplary embodiment, the protruding abutment includes side support surfaces 144a between a given support surface 150 and the abutting surface 140 and side cutting surfaces 144b between a given cutting surface 130 and the abutting surface 140. In some embodiments, the side support surfaces 144a can provide a surface upon which the cutting tool 100 abuts a tool holder. The side cutting surfaces 144a can have an engagement surface that extends the entire length of the protruding abutment or any length thereof and can have a surface that is configured to engage with a corresponding surface on the tool holder, such as a groove and rail or protrusion and depression engagement. In the exemplary embodiment, the side support surfaces 144a are planar and are configured engage with the tool holder.

When the cutting tool 100 is in use on a cutting drum, the cutting side surfaces 144b on the first or second side 100a, 100b of the cutting tool 100 are on the leading side thereof, when the first or second side 100a, 100b is the leading side. In some embodiments, the cutting side surfaces 144b can be curved, chamfered, rounded, etc., for example to prevent the organic material being mulched from catching or snagging on the protruding abutting surface 140, which can increase an overall cutting resistance of the cutting drum. The cutting side surfaces 144b can also be configured to help deflect shredded material during use and/or to provide a better fit between the cutting tool 100 and the associated tool holder the cutting tool 100 is coupled to the cutting drum with. In the exemplary embodiment, the cutting side surfaces 144b include two concave recesses that each extend partially along the length of the protruding abutment. The cutting side surfaces 144b are separated by a bridge 146 that has the same protruding height as the protruding abutment. However other configurations are also possible, such as a bridge 146 with a smaller or greater protruding height as the protruding abutment.

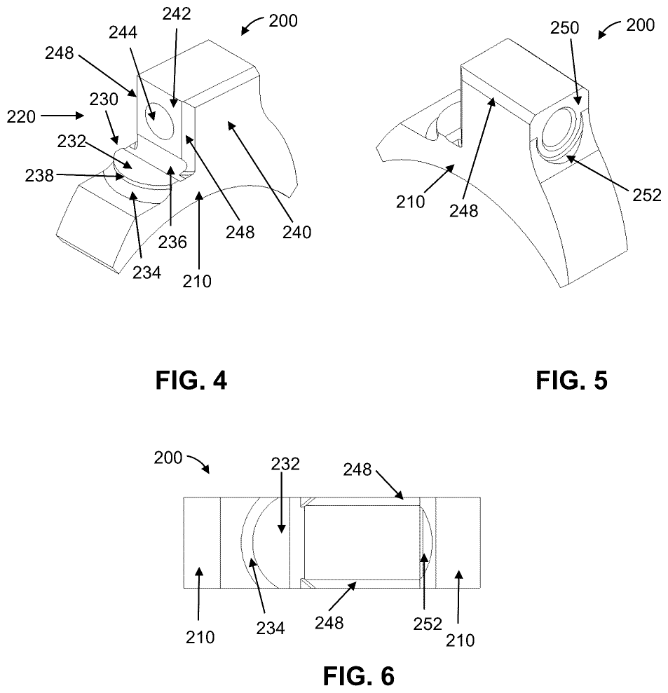

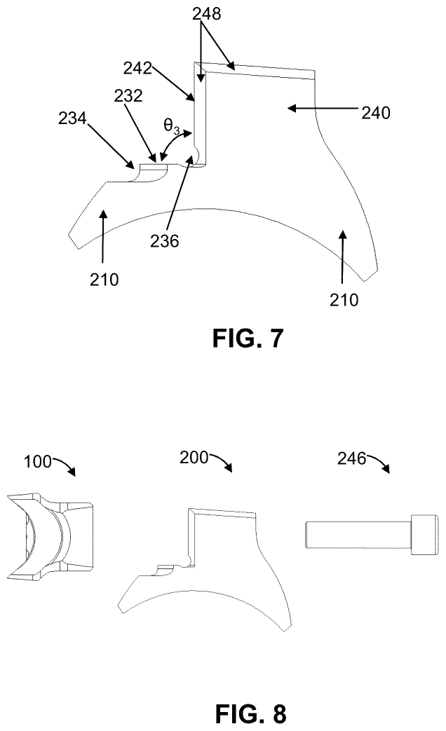

Referring now to FIGS. 4 to 6, a tool holder 200 according to one embodiment is shown. The tool holder 200 includes a base 210 configured to couple or mount onto a cutting drum and a body 220 configured to engage with and support a cutting tool. The body 220 can engage with the cutting tool to removably couple the cutting tool to the tool holder 200, for example, with a wedge, interference fit, and/or fastener. In the exemplary embodiment, the body 220 includes a cutting tool support platform 230 configured to engage with an underside (cutting drum facing side) of the cutting tool and a protrusion 240 having an abutting face 242 configured to engage with a trailing side of the cutting tool.

In some embodiments, the cutting tool support platform 230 includes a support face 232 that is configured to engage with underside (cutting drum facing side) of the cutting tool. For example, when used with cutting tool 100, the support face 232 is configured to engage with the support surface 150 on the cutting drum facing side of the cutting tool 100. In the exemplary embodiment, the support face 232 is planar and has a convex shape with a leading side 238 that is configured to abut against the recess surface 160 adjacent to the support surface 150 (the recess surface 160 adjacent to the relief surface 120 of the opposing cutting edge 110_{O} to the cutting edge 110_{CP} in the cutting path). Other configurations of engagement between the support surface 150 (or an underside of a cutting tool) and the support face 232 are possible, such as groove and rail, protrusion and depressions, etc. Consideration to the pressure and movement that the cutting tool is subjected to should be given when determining the engagement surfaces between the underside of the cutting tool and the top side of the cutting tool 200. In the exemplary embodiment, the engagement between the convex curve on the support face 232 and the concave surface of the recess surface 160 acts to prevent a rotation of cutting tool 100 when in use.

In some embodiments, the cutting tool support platform 230 can include a recess 234 on a leading side of the cutting tool support platform 230. The recess 234 provides additional space for the opposing cutting edge 110_{O} to the cutting edge 110_{CP} in the cutting path, as is best shown in FIG. 9A. The cutting tool support platform 230 can further include a depression 236, such as an inverted bullnose corner, on a trailing side of the cutting tool support platform 230. The depression 236 provides a surface for a trailing side of the cutting tool, such as the abutting surface 140 on cutting tool 100, to abut and engage with. In some embodiments, the engagement between the depression 236 and the trialing side of the cutting tool can further prevent the rotation of the cutting tool when in use.

When a cutting tool is coupled to the tool holder 200, a trailing side of the cutting tool engages with and is reversible coupled to a leading side of the protrusion 240. In the exemplary embodiment, when used with cutting tool 100, the abutting face 242 on the protrusion 240 is configured to abut with the abutting surface 140. In some embodiments, the abutting face 242 and the abutting surface 140 can have engagement features to prevent a rotation thereof; however, consideration should be given to the cutting tool's ability to be rotated to access the opposing cutting edge. In the exemplary embodiment, the abutting face 242 and the abutting surface 140 are a planar surfaces that are configured to abut. In this embodiment, the abutting surface 140 is substantially perpendicular to a central axis of the aperture 244 (which is coaxial with a central axis of the aperture 142 and the central axis A of the fastener 246). In some embodiments, the angle θ₃ between the support face 232 and the abutting face 242 is between about 90° and about 120°, or between about 90° and about 100°. In the exemplary embodiment, the support face 232 and the abutting face 242 are perpendicular to each other (i.e., having an angle θ₃ of 90° relative to each other).

In some embodiments, when the angle θ₃ between the support face 232 and the abutting face 242 is greater than about 90°, the abutting surface can be provided at a complimentary angle, such that the abutting surface 140 and the abutting face 242 are abutting or superimposed against each other. In some embodiments, the abutting face 242 and the abutting surface 140 have complimentary symmetrical surfaces, such that the abutting surface 140 can be coupled to the abutting face 242 in at least two directions (i.e., the abutting surface 140 and the abutting face 242 are couplable in a first position and a second position).

The cutting tool can be coupled to the tool holder 200 using any known means of coupling, such as with a fastener, welding, interference fit, wedges, etc. In the exemplary embodiment, the protrusion 240 includes an aperture 244 extending along the length thereof that is configured to receive a fastener 246. The aperture 244 is configured to align with an aperture in a cutting tool, such as aperture 142, to secure the cutting tool to the tool holder 200. When in use with a cutting tool, such as cutting tool 100, the fastener 246 extends through the aperture 244 in the protrusion 240 from a trailing side thereof, through the aperture 142 in the cutting tool 100, and is secured on a leading side of the cutting tool 100. In some embodiments, the fastener 246 can extend through the aperture 142 in a leading side of the cutting tool 100, through the aperture 244 in the protrusion 240 from a leading side thereof and is secured on a trailing side of the tool holder 200. In some embodiments, the aperture 142 in the cutting tool 100 and/or the aperture 244 in the tool holder 200 can be threaded, such that neither the leading side nor the trailing side of the cutting tool 100 includes a securing means for the fastener 246, such as a threaded nut.

The protrusion 240 can include a trailing surface 250 on a trailing side thereof. In the exemplary embodiment, the trailing surface 250 includes a recessed area 252 configured to receive the fastener 246 or a securing means therefor, such as a threaded nut. In some embodiments, the recessed area 252 and/or the protruding abutment can have a size and orientation that provides protection for the fastener 246 and/or the securing means therefor during the tool holder's 200 use on a cutting drum.

In some embodiments, the protrusion 240 includes chamfered edges 248 along a leading side thereof and a top side thereof. Providing chamfered edges 248 on the leading and top sides of the protrusion 240 can prevent the organic material being mulched from catching on the tool holder 200, which can increase an overall cutting resistance of the cutting drum. In some implementations, the cutting side surfaces 144b and/or the cutting surface 130 are configured to engage with the chamfered edges 248, such as two planar surfaces, groove and rail surfaces, protrusion and depression surfaces, etc.

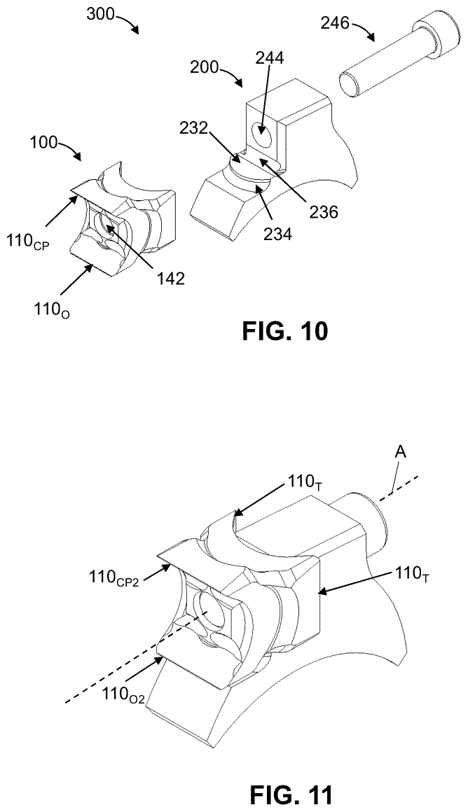

Referring now to FIGS. 9A to 12, a cutting tool system 300 is shown. The cutting tool system 300 includes a cutting tool having a first side and a second side, each with at least one cutting edge, and a tool holder configured to couple to a cutting drum and reversibly couple to the cutting tool. In the exemplary embodiment, the cutting tool system 300 includes the cutting tool 100 and the tool holders 200 discussed herein.

As is best shown in FIGS. 9A and 9B, the support surface 150 on the cutting tool 100 engages with and/or abuts against the support face 232 on the tool holder 200. The depression 236 on the tool holder 200 provides space for the relief surface 120 on the cutting tool. In some embodiments, the cutting tool 100 can include a chamfer at an apex between the support surface 150 and the abutting surface 140, such that the depression 236 on the tool holder 200 is not required. In some embodiments, the leading side 238 (not shown) of the support face 232 directly engages and/or abuts the recess surface 160. When the first side 100a of the cutting tool 100 is in the cutting path, the abutting surface 140 on the second side 100b of the cutting tool 100 engages with and/or abuts the abutting face 242 on the tool holder 200. In the exemplary embodiment, when the cutting tool 100 is reversibly coupled to the tool holder 200, as is best shown in FIG. 9, the cutting surfaces 130 on the second side 100b of the cutting tool 100 are adjacent to or abut the chamfered edges 238 on the protrusion 240, such that the trailing cutting edges 110_{T} extend past the chamfered edges 248. In some embodiments, the chamfered edges 248 can have a complimentary or corresponding shape to the cutting surface 130, such that the cutting surface 130 and the chamfered edges 248 directly abut.

When in use with a cutting drum, as the cutting drum rotates in the direction of rotation D_{R}, one of the first or second sides 100a, 100b is on a leading side 300a of the cutting tool system 300 and the other side if on a trailing side 300b thereof. In the exemplary embodiment, in a first position, the first side 100a of the cutting tool 100 is on a leading side 300a, such that one of the cutting edges 110 on the first side 100a is the cutting edge 110_{CP} in the cutting path and the opposing cutting edge 110_{O} is on the leading side 300a outside of the cutting path. The cutting drum can be rotated to mulch, grind, or otherwise size-reduce the organic material being mulched using the cutting edge 110_{CP} in the cutting path. When the cutting edge 110_{CP} in the cutting path becomes dull or blunt, the fastener 246 can be loosened or removed and the cutting tool 100 can be rotated 180° around the central axis of the aperture 142, which is coaxial with a center axis A of the fastener 246. Once rotated 180° around the center axis A of the fastener 246, the opposing cutting edge 110_{O} becomes the cutting edge 110_{CP} in the cutting path in a second position. Accordingly, the cutting tool 100 is rotatable to provide two wear or erosion lives on the first side 100a. When the cutting edge 110_{CP2} in the cutting path for the second position, as shown in FIG. 11 (i.e., the cutting edge 110_{CP2} in the cutting path corresponding to the cutting edge 110_{O} shown in FIG. 9A in the first position) becomes dull or blunt, the cutting edge 110_{CP2} and/or the opposing cutting edge 110_{O2} (corresponding to the cutting edge 110_{CP} in the cutting path shown in FIG. 9A in the first position) can be mechanically or manually sharpened. The curvature of the base 210 of the tool holder 200 provides space for the opposing cutting edge 110_{O} or 110_{O2} to be sharpened.

Once the erosion or wear life of the cutting edges 110 on the first side 100a of the cutting tool 100 are exhausted, the cutting tool 100 can be reversed to utilize the trailing cutting edges 110_{T} . The fastener 246 is removed from the aperture 142 of the cutting tool 100, such that the cutting tool can be rotated 180° around an axis perpendicular to the center axis A of the fastener 246 and rotated 90° around the center axis A of the fastener 246, such that the second side 100b of the cutting tool is placed on the leading side 300a in a third position (not shown). In such embodiments, one of the trailing cutting edges 110_{T} shown in FIGS. 9A and 11 becomes the cutting edge in the cutting path and the other cutting edge becomes the opposing cutting edge, thus providing two additional erosion or wear lives to the cutting tool 100 (i.e., a third position and a fourth position).

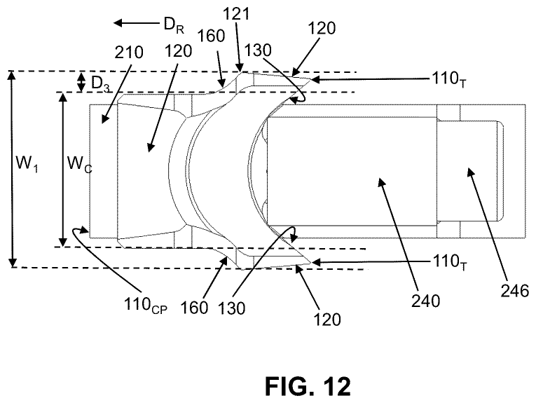

With specific reference to FIG. 12, a top view of the cutting tool system 300 is shown. When rotated in the direction of rotation D_{R1} the cutting path (defined by the cutting edge 110_{CP} in the cutting path) has a width W_{C}. In the exemplary embodiment, as the first and second sides 100a, 100b of the cutting tool 100 are offset from each other and separated by the recess surface 160, an overall width W_{BL} of the cutting tool 100 (corresponding to the distance between the two apexes 121 between the adjacent relief surface 120 and the recess surface 160) is greater than the width W_{C} of the cutting path. In some embodiments, the relief surface 120 can be tapered laterally inwardly from the apex with the recess surface 160, such that the trailing cutting edges 110_{T} are provided laterally inwardly from the apex 121 of the relief surface 120 and the recess surface 160. In some embodiments, the relief surface 120 can be tapered, at least partially, to protect the trailing cutting edges 110_{T} from the organic material being mulched, ground, or otherwise size-reduced by the cutting edge 110_{CP} in the cutting path. The tapered relief surface 120 can also act to protect the protrusion 240 on the tool holder 200, for example from debris being expelled from the cutting edge 110_{CP} in the cutting path.

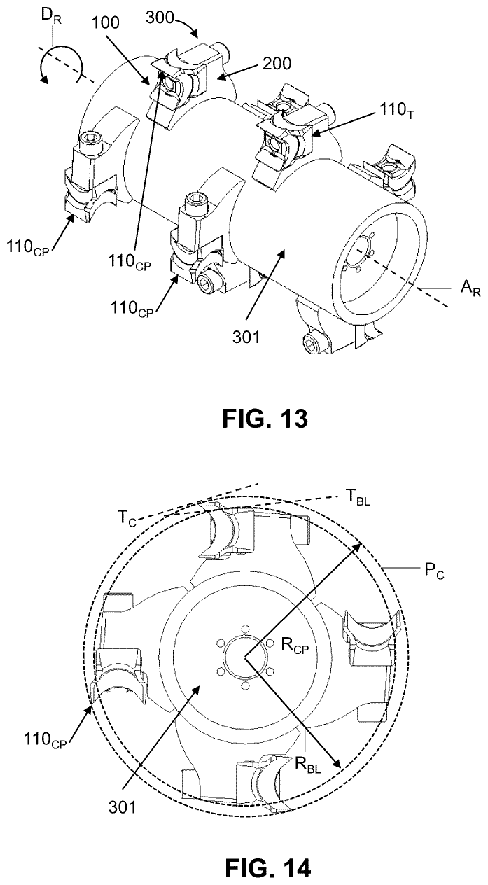

Referring now to FIGS. 13 and 14, multiple cutting tool systems 300 are shown coupled to a cutting drum 301 (which can also be referred to as a rotary drum). The cutting tool systems 300 are coupled to an outer surface of the cutting drum 301 in a spaced apart manner around the circumference of the cutting drum 301 so as to reduce the amount of material the cutting edges have access to. In the exemplary embodiment, the cutting tool systems 300 are offset from each other and spaced apart in a spiral or helical configuration.

As is best shown in FIG. 14, the cutting drum 301 has a cutting radius R_{CP} that is defined as the distance between the axis of rotation A_{R} of the cutting drum 301 and the cutting edges 110_{CP} in the cutting path P_{C}. A tangential cutting line T_{C} that extends at a tangent from the cutting edges 110_{CP} in the cutting path P_{C} shows where the cutting, mulching, and/or grinding action takes place.

In some embodiments, the cutting tool systems 300 can act as a bite limiter, which can prevent the mulcher head (the cutting drum 301 and the cutting tool systems 300) from slowing down or stalling by limiting the amount of material a given cutting edge 110_{CP} in the cutting path has access to. As is best shown in FIG. 14, the bite limiter has a radius R_{BL} that is smaller than the cutting path radius R_{CP} by a distance that is approximately equal to a distance D₃ between the support surface 120 and the support surface 150, as is best shown in FIG. 12. A tangential bite limiter line T_{BL} that extends at a tangent from the bite limiter radius R_{BL} shows where the material being mulched is limited from entering the cutting path (i.e., limited by the difference between the cutting path radius R_{CP} and the bite limiter radius R_{BL}).

In some embodiments, the support surface 150 on the trailing side 300b of the cutting tool 100 and/or the top surface of the protrusion 240 of the tool holder 200 can act to reduce the amount of organic material the cutting edge 110_{CP} in the cutting path has access. In other words, the support surface 150 and/or the protrusion 140 can act to limit the depth of material the cutting edge 110_{CP} in the cutting path has to access to the distance D₃ between the support surface 120 and the support surface 150. In the exemplary embodiment, the support surface 150 and the protrusion 240 are substantially coplanar, such that both the support surface 150 and the protrusion 240 act collectively as the bite limiter.

When in use, the relief surfaces 120 can be worn down, or worn down and sharpened continuously, until the cutting edge 110_{CP} in the cutting path is level or flush with the support surface 150 on the trailing side 300b. In other words, the cutting edge 110_{CP} in the cutting path can be used and sharpened until the cutting path radius R_{CP} equals the bite limiter radius R_{BL}.

In some embodiments, the relief surfaces 120 on the trailing side 300b of the cutting tools 100 can act as a bite limiter in the lateral direction and/or act to protect the trailing cutting edges 110_{T}. For example, when the cutting edge 110_{CP} in the cutting path is unworn (as shown in FIG. 14), the portion of the material that is not within the cutting path width W_{C} will contact the recess surface 160 on the trailing side 300b (exemplified by the difference between the bite limiter width W_{BL} and the cutting path width W_{C}) if the bite depth in the cutting path P_{C} exceeds the difference between the cutting path radius R_{C} and the bite limiter radius R_{BL}. The recess surface 160 further acts to protect the trailing cutting edges 110_{T} and keep them sharp when the recess surface 160 comes into contact with the uncut material in the area between the bite limiter width W_{BL} minus the cutting path width W_{CP} because of the relief angle θ₁ of the relief surface 120.

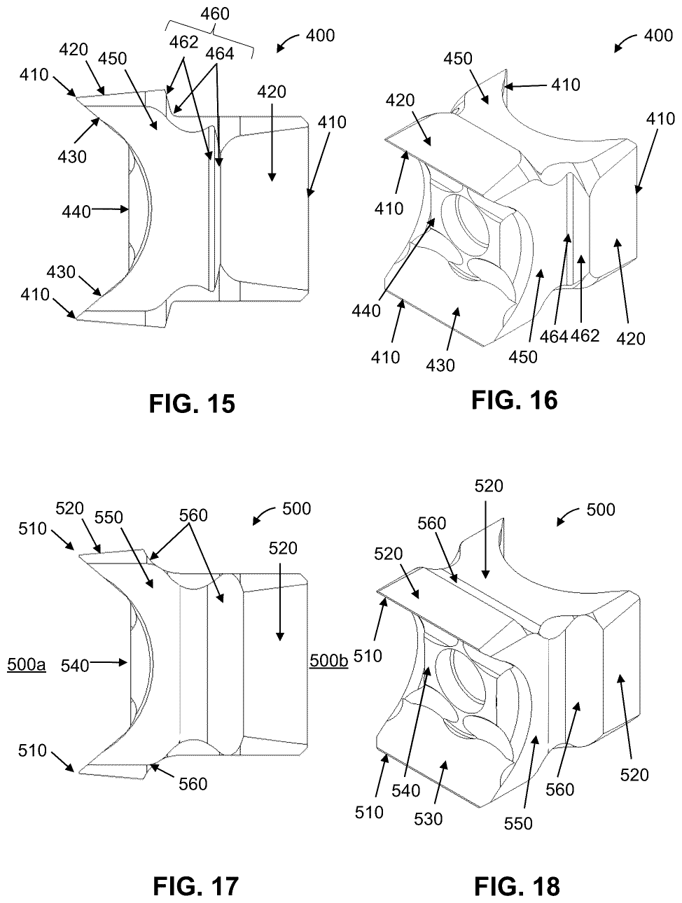

Referring now to FIGS. 15 and 16, a cutting tool 400 according to another embodiment is shown. The cutting tool 400 includes cutting edges 410, relief surfaces 420, cutting surfaces 430, abutting surfaces 440, support surfaces 450, and recess surfaces 460. The cutting tool 400 includes substantially the same features as the cutting tool 100 except for the shape and configuration of the recess surfaces 460. In the exemplary embodiment, the recess surfaces 460 include a tapered planar surface 462 that is separated from the adjacent support surface 450 by a small radius 464.

Referring now to FIGS. 17 and 18, a cutting tool 500 according to another embodiment is shown. The cutting tool 500 includes cutting edges 510, relief surfaces 520, cutting surfaces 530, abutting surfaces 540, support surfaces 550, and recess surfaces 560. The cutting tool 500 includes substantially the same features as the cutting tool 400 except for the shape and configuration of the recess surfaces 560. In the exemplary embodiment, the recess surfaces 560 has a curved surface with a continuous radius between the relief surface 520 on a leading or first side 500a of the cutting tool 500 and the support surface 550 on a trailing or second side 500b of the cutting tool 500.

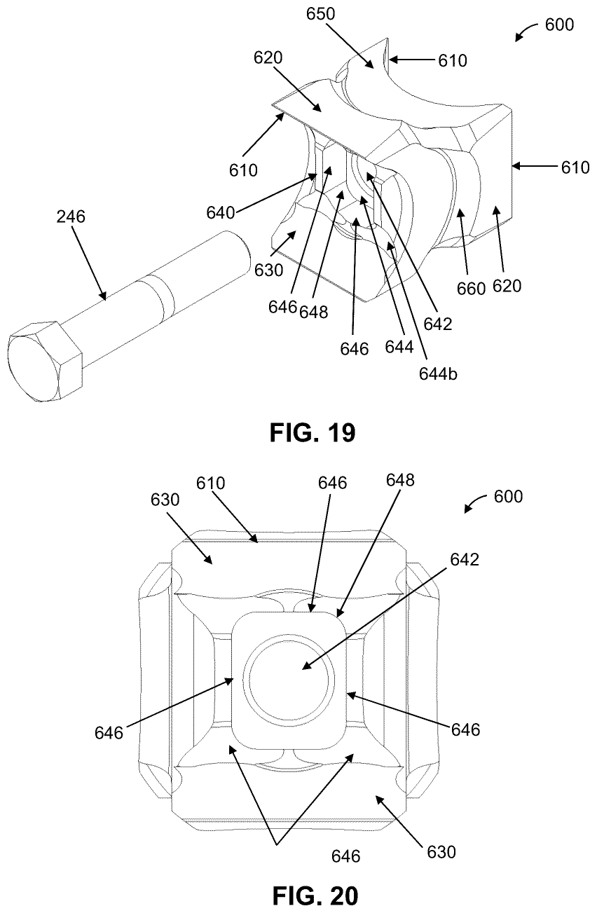

Referring now to FIGS. 19 and 20, a cutting tool 600 according to another embodiment is shown. The cutting tool 600 includes cutting edges 610, relief surfaces 620, cutting surfaces 630, abutting surfaces 640, support surfaces 650, and recess surfaces 660. The cutting tool 600 includes substantially the same features as the cutting tool 100 except for the abutting surfaces 640. In the exemplary embodiment, the cutting tool 600 includes an aperture 642 extending between the abutting surfaces 640. Each of the abutting surfaces 640 include a recess or pocket 644 around the aperture 642 that is configured to receive the head 246a of a fastener 246, such as a bolt head, and/or a securing means for the fastener 246, such as a threaded nut (not shown). The pocket 644 includes at least three surfaces, with at least one of the surfaces acting as a rotation stopper for the head 246a and/or the securing means of the fastener 246. In the exemplary embodiment, the pocket 644 has four side surfaces 646 and curved corners 468 between adjacent side surfaces 464. In some embodiments, the pocket 644 is configured to protect the fastener from debris, dirt, or other particulate material.

In the exemplary embodiment, the fastener 246 is an unthreaded bolt that requires a securing means, such as a threaded nut, which can fit within the pocket 644 on the abutting surface 660 on the opposing side of the cutting tool 600 than the head 246a of the fastener 246.

In some embodiments, the abutting surface 640 can further include cutting side surfaces 644b between the cutting surface 630 and the abutting surface 640. In the exemplary embodiment, the cutting side surfaces 644b are curved surfaces.

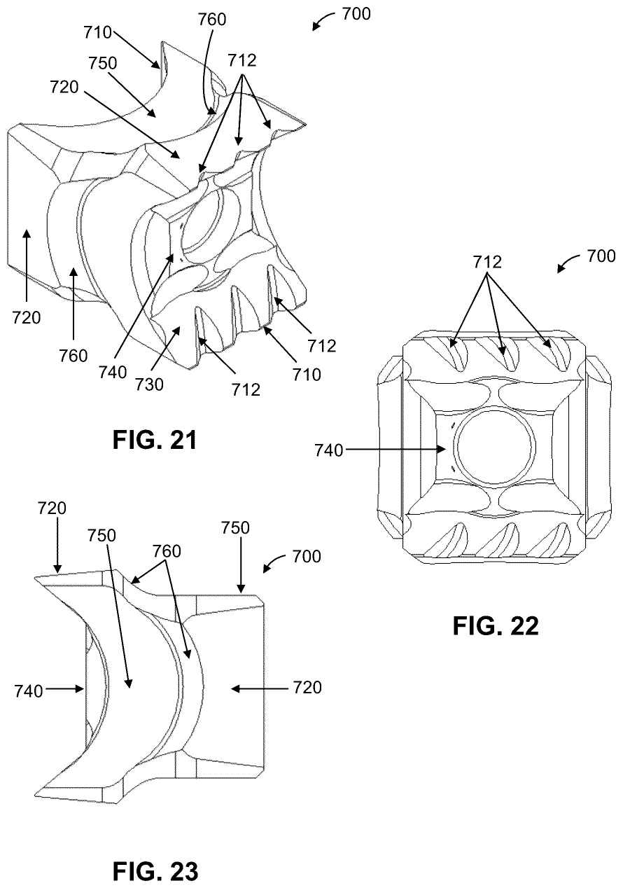

Referring now to FIGS. 21 to 23, a cutting tool 700 according to another embodiment is shown. The cutting tool 700 includes cutting edges 710, relief surfaces 720, cutting surfaces 730, abutting surfaces 740, support surfaces 750, and recess surfaces 760. The cutting tool 700 includes substantially the same features as the cutting tool 100 except for the cutting edges 710. In the exemplary embodiment, each of the cutting edges 710 include grooves 712 extending through the cutting edge to provide additional groove edges. In such embodiments, the cutting edges 710 have edge surfaces that extend in a plane that is different from an edge plane of the given cutting edge 710.

The grooves 712 or serrations increase the wear or erosion life of the cutting tool and contributes to reduction in cutting resistance, even after a long interval of utilisation. The reduction in cutting resistance is retained without external interventions, such as mechanical grinding, buffing, or sharpening. The cutting tools also have improved debris discharge features. To reduce the cutting resistance in the cutting plane, the cutting tools can have a cutting edge that includes at least three edges extending in at least three planes or directions. In some embodiments, the cutting edges include one or more grooves or serrations that add at least two edges to the cutting edge on the cutting tool. In some embodiments, the cutting edge can include edge surfaces extending in a plane that is different from an edge plane of the at least one cutting edge. In some embodiments, the cutting edge can include grooves or serrations that have edge surfaces extending in a plane different than a plane of the cutting edge.

When the rotary cutting drum (or in some embodiments, the rotary disc) is rotated, the cutting tools 700 are susceptible to damage from impacting objects other than the organic material being shredded or grinded, such as rocks. The cutting tools 700 with grooves 712 or optionally, serrations, can be resistant to dents or other damage on the edges of the cutting tool 700. Moreover, in contrast to straight cutting edges, resistance to dents or damage on the cutting edge 710 can improve as the cutting tool 700 is being used (i.e., as the cutting edges 710 are worn down from use) as the cutting edges 710 and surfaces of the cutting tool become rounded, which spreads the impact load of the non-organic material more evenly on the cutting edges 710 without drastically reducing the productivity of the cutting tool 700.

In some embodiments, the grooves 712 or serrations on the cutting edge 710 of the cutting tool 700 can provide improved debris discharge features and contribute to producing a smaller size of the shredded material. As the cutting edge 710 hits the material being shredded first, the grooves 712 or serrations provide less surface area available to the material at the first point of contact than a straight blade. After the initial or first point of contact, the groove edges of the groove 712 then come into contact with the material, producing a smaller sized material, which can be desirable as the shredded organic matter will decompose faster than larger pieces. These smaller pieces of shredded organic matter can be directed through the grooves 712 on the leading side of the cutting tool 700, thus providing better debris discharge.

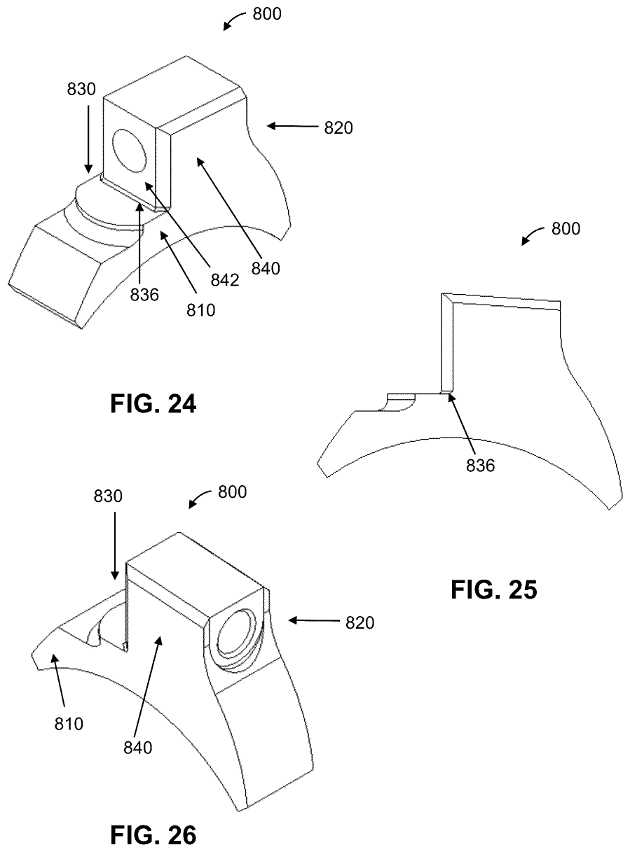

Referring now to FIGS. 24 to 26, a tool holder 800 according to another embodiment is shown. The tool holder 800 includes a base 810 configured to couple or mount onto a cutting drum and a body 820 configured to engage with and support a cutting tool. The body 820 includes a cutting tool support platform 830 configured to engage with an underside (cutting drum facing side) of the cutting tool and a protrusion 840 having an abutting face 842 configured to engage with a trailing side of the cutting tool. The tool holder 800 includes substantially the same features as the tool holder 200 except for the connection between the abutting face 842 on the protrusion 840 and the cutting tool support platform 830. In the exemplary embodiment, the cutting tool support platform 830 includes a chamfered edge 836 (as opposed to a depression 236) on a trailing side of the cutting tool support platform 830. The chamfered edge 836 provides a surface for a trailing side of the cutting tool to abut and engage with. For example, the chamfered edge 836 on the tool holder 800 can abut and/or engage with a chamfered apex between the support surface 150 and the abutting surface 140 of the cutting tool 100.

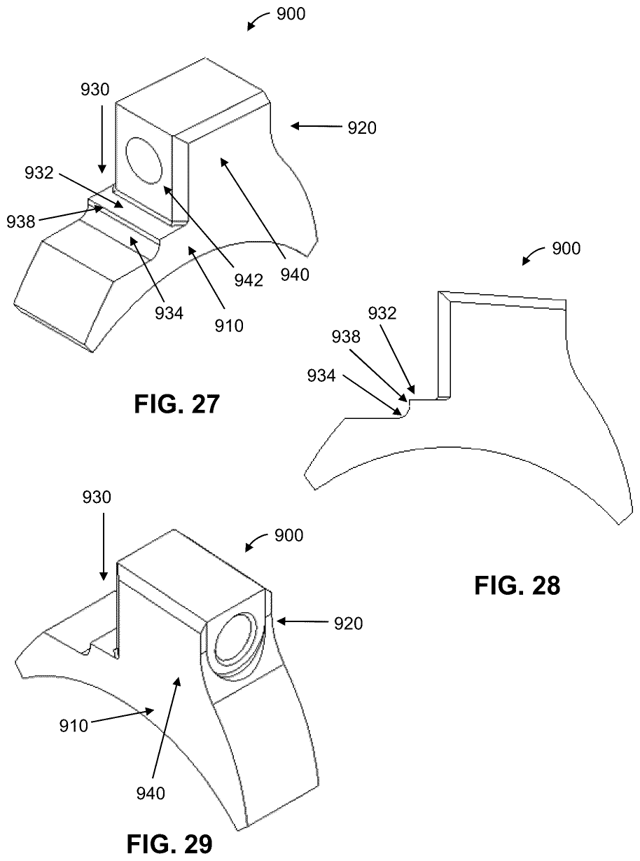

Referring now to FIGS. 27 to 29, a tool holder 900 according to another embodiment is shown. The tool holder 900 includes a base 910 configured to couple or mount onto a cutting drum and a body 920 configured to engage with and support a cutting tool. The body 920 includes a cutting tool support platform 930 configured to engage with an underside (cutting drum facing side) of the cutting tool and a protrusion 940 having an abutting face 942 configured to engage with a trailing side of the cutting tool. The tool holder 900 includes substantially the same features as the tool holder 200 except for the cutting tool support platform 930. In the exemplary embodiment, the cutting tool support platform 930 includes a support face 932 that is configured to engage with underside (cutting drum facing side) of the cutting tool and a recess 934 on a leading side of the cutting tool support platform 930. In this embodiment, the support face 932 has a leading edge 938 that is planar (as opposed to leading edge 238, which is curved). For example, when used with cutting tools 400, 500 (shown in FIGS. 15 to 18) that have a recess surface 460, 560 that is not curved (such as, being substantially parallel to the adjacent cutting surface 410, 510), the leading edge 938 of the support face 932 is configured to abut against the recess surface 460, 560 adjacent to the support surface 450, 550. In the exemplary embodiment, the engagement between the straight surface on the leading edge 938 on the support face 932 and the straight surface of the recess surface 460, 560 acts to prevent a rotation of cutting tool 400, 500 when in use.

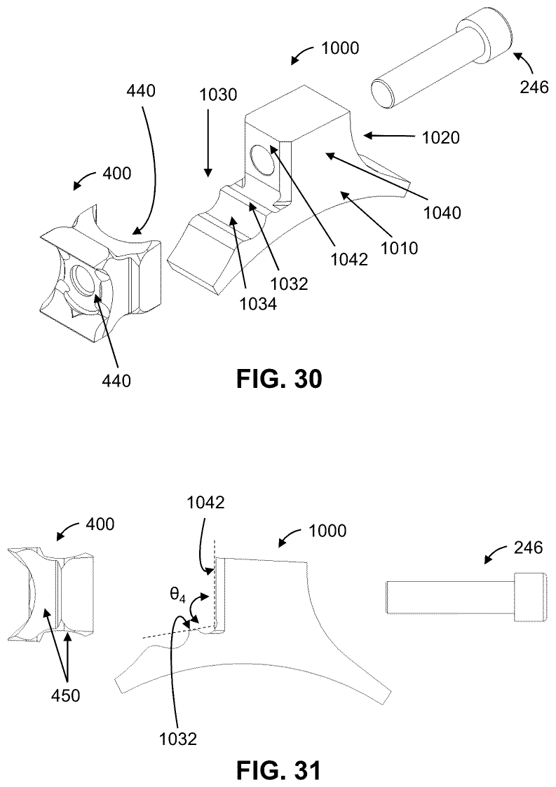

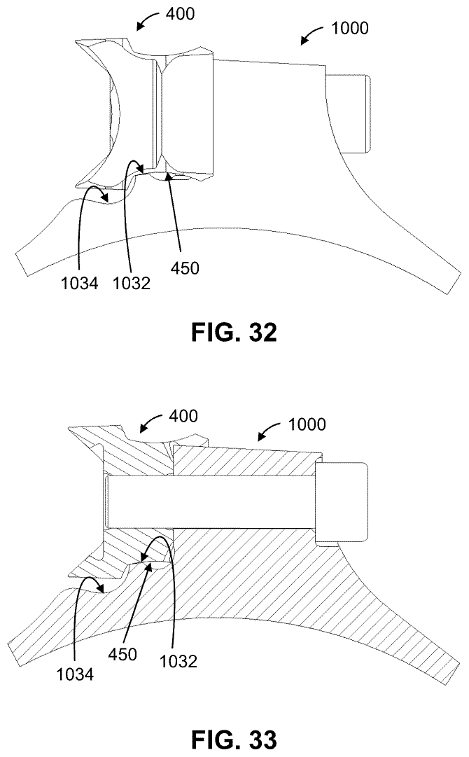

Referring now to FIGS. 30 to 33, a cutting tool system according to another embodiment is shown. The cutting tool system includes a tool holder 1000 according to another embodiment coupled to a cutting tool 400 with a fastener 246. The tool holder 1000 includes a base 1010 configured to couple or mount onto a cutting drum and a body 1020 configured to engage with and support the cutting tool 400. The body 1020 includes a cutting tool support platform 1030 configured to engage with an underside (cutting drum facing side) of the cutting tool and a protrusion 1040 having an abutting face 1042 configured to engage with the trailing side of the cutting tool 400. In the exemplary embodiment, the abutting face 1042 engages with the abutting surface 440 on the trailing side of the cutting tool 400.

The tool holder 1000 includes substantially the same features as the tool holder 900 except for the cutting tool support platform 1030. In the exemplary embodiment, the cutting tool support platform 1030 includes a support face 1032 that is configured to engage with underside (cutting drum facing side) of the cutting tool and a recess 1034 on a leading side of the support face 1032. In the exemplary embodiment, the support face 1032 engages with the support surface 450 on the cutting drum facing side of the cutting tool 400. In the exemplary embodiment, the support face 1032 is provided at an angle θ₄ to the abutting face 1042 of the protrusion 1040 that is greater than 90°, for example between about 91° and about 120°. In some embodiments, the angle θ₄ is between about 95° and about 100°. In the exemplary embodiment, the angle θ₄ between the support face 1032 and the abutting face 1042 of the protrusion 1040 is about 97°. As shown best in FIGS. 30 and 31, when used with a cutting tool 400, an apex between the support face 1032 and the recess 1034 abuts against the recess surface 460 adjacent to the support surface 450 and prevents a rotation of the cutting tool 400 when in use.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A cutting tool system comprising:
a tool holder comprising a base for mounting onto a rotary drum or disc and a body; and
a cutting tool for size-reducing a material, the cutting tool having a first side and a second side and being configured to couple to the body of the tool holder, the cutting tool comprising a plurality of cutting edges that are selectively moveable into and out of a cutting path of the rotary drum or disc, wherein the first side and the second side each have at least one of the plurality of cutting edges, such that each of the first side and the second side are configured to be a leading side of the cutting tool.

2. The cutting tool system of claim 1, wherein each of the first side and the second side comprise:
a cutting side having cutting surfaces and an abutting surface positioned between the cutting surfaces;
a side opposing the cutting side;
opposing relief surfaces adjacent to the cutting side; and
opposing support surfaces extending between the opposing relief surfaces.

3. The cutting tool system of claim 2, wherein the plurality of cutting edges comprises opposing cutting edges at an apex of a given one of the opposing relief surfaces and an adjacent one of the cutting surfaces on the first side and the second side.

4. The cutting tool system of claim 2, wherein the side opposing the cutting side of the first side and the side opposing the cutting side of the second side are adjacent and coupled at 90° relative to each other such that a given one of the opposing relief surfaces on the first side is on a same side of the cutting tool as a given one of the opposing support surfaces on the second side of the cutting tool.

5. The cutting tool system of claim 2, wherein the body of the tool holder further comprises cutting tool support platform having a support face configured to engage with a rotary drum or disc facing side of the cutting tool and a protrusion having an abutting face configured to engage with the abutting surface on a trailing side of the tool holder.

6. The cutting tool system of claim 5, wherein at least one of:
when coupled to the tool holder, a given one of the opposing support surfaces and a top side of the protrusion are coplanar;
the protrusion comprises a tool holder aperture extending through the protrusion and the cutting tool further comprises a cutting tool aperture extending between the abutting surface on the first side and the abutting surface on the second side, wherein, when reversible coupled thereto, the tool holder aperture and the cutting tool aperture are configured to align to define a central axis of the cutting tool system and receive a fastener to reversibly couple the cutting tool to the tool holder on the rotary drum or disc;
the support face on the cutting tool support platform is configured to engage with a given one of the opposing support surfaces of the cutting tool; and
the support face and the abutting face are provided at an angle of between about 90° and about 120° or between about 90° and about 100°.

7. The cutting tool system of claim 6, wherein at least one of:
the cutting tool is configured to be rotated around the central axis to selectively move the plurality of cutting edges into and out of the cutting path; and
the cutting tool is configured to be rotated around an axis perpendicular to the central axis to selectively move the plurality of cutting edges into and out of the cutting path.

8. The cutting tool system of claim 6, wherein the support face has a protruding convex shape with a leading side that is configured to abut against a recess surface adjacent to the given one of the opposing support surfaces, wherein the recess surface is between an adjacent one of the opposing relief surfaces and the given one of the opposing support surfaces on an opposing one of the first side and the second side.

9. The cutting tool system of claim 2, wherein the abutting surface on the first side and the abutting surface on the second side protrude past an edge of the opposing support surfaces to form a protruding abutment comprising:
side support surfaces between an adjacent one of the opposing support surfaces and the abutting surface; and
cutting side surfaces between an adjacent one of the cutting surfaces and the abutting surface.

10. The cutting tool system of claim 9, wherein a leading side of the body comprises chamfered edges, and wherein at least one of:
when reversible coupled, the chamfered edges and the cutting side surfaces are configured to engage with each other; and
when reversible coupled, the chamfered edges and the cutting surfaces are configured to engage with each other.

11. The cutting tool system of claim 8, wherein each of the opposing relief surfaces are angled laterally inwardly from an apex with the recess surface at a relief angle of between about 0.5° and about 15° or between about 1° and about 3°.

12. The cutting tool system of claim 1, further comprising the rotary drum or disc, wherein the tool holders are coupled to an outer surface of the rotary drum or disc in a spaced apart manner configured to limit an amount of the material a given one of the plurality of cutting edges in the cutting path has access to.

13. The cutting tool system of claim 12, wherein the tool holders are spaced apart in a spiral or helical configuration.

14. A cutting tool for mounting onto a rotary drum or disc for shredding a material, the cutting tool having a first side and a second side each configured to be a leading side of the cutting tool, each of the first side and the second side comprising:
a cutting side having cutting surfaces and an abutting surface positioned between the cutting surfaces;
a side opposing the cutting side;
opposing relief surfaces adjacent to the cutting side;
opposing support surfaces extending between the opposing relief surfaces; and
opposing cutting edges at an apex of a given one of the opposing relief surfaces and an adjacent one of the cutting surfaces;
wherein the side opposing the cutting side of the first side and the side opposing the cutting side of the second side are adjacent and coupled at 90° relative to each other such that a given one of the opposing relief surfaces on the first side is on a same side of the cutting tool as a given one of the opposing support surfaces on the second side of the cutting tool.

15. The cutting tool of claim 14, further comprising an aperture extending between the abutting surface on the first side and the abutting surface on the second side, the aperture being configured to receive a fastener to reversibly couple the cutting tool to the rotary drum or disc or a tool holder on the rotary drum or disc, wherein the aperture defines a central axis of the cutting tool, and wherein at least one of:
the cutting tool is configured to be rotated around the central axis of the aperture to selectively move the opposing cutting edges of the first side or the second side into and out of a cutting path of the rotary drum or disc; and
the cutting tool is configured to be rotated around an axis perpendicular to the central axis of the aperture to selectively move the opposing cutting edges of the first side or the second side into and out of a cutting path of the rotary drum or disc.

16. The cutting tool of claim 14, further comprising a recess surface between the given one of the opposing relief surfaces on the first side and the given one of the opposing support surfaces on the second side and/or between the given one of the opposing relief surfaces on the second side and the given one of the opposing support surfaces on the first side.

17. The cutting tool of claim 16, wherein adjacent ones of the given one of the opposing relief surfaces and the given one of the opposing support surfaces are offset from each other such that the recess surface extends in a different direction than the adjacent ones of the given one of the opposing relief surfaces and the given one of the opposing support surfaces.

18. The cutting tool of claim 14, wherein the abutting surface on the first side and the abutting surface on the second side protrude past an edge of the support surface to form a protruding abutment.

19. The cutting tool of claim 18, wherein the protruding abutment comprises:
side support surfaces between an adjacent one of the opposing support surfaces and the abutting surface; and
cutting side surfaces between an adjacent one of the cutting surfaces and the abutting surface;
wherein the side support surfaces are configured to abut a corresponding surface on the rotary drum or disc or a tool holder on the rotary drum or disc.

20. A cutting tool for mounting onto a rotary drum or disc for size-reducing a material, the cutting tool comprising a plurality of cutting edges, wherein the cutting tool is configured to be reversible and rotatable, such that each of the plurality of cutting edges are configured to be a cutting edge in the cutting path.
